(19) United States
(12) Patent Application Publication
(10) Pub. No.: US 2026/0094403 A1
(43) Pub. Date: Apr. 2, 2026

(54) Video Analytics Based System for Weapon Detection

(71) Applicant: MOTOROLA SOLUTIONS, INC., CHICAGO, IL (US)

(72) Inventors: BRIAN J FROMMELT, DARIAN, IL (US); THE SON HOANG, CHICAGO, IL (US)

(21) Appl. No.: 18/904,328

(22) Filed: Oct. 2, 2024

(51) Int. Cl. G06V 10/26; G06V 10/764; G06V 10/98; G06V 20/52; G06V 20/64

(52) U.S. Cl. CPC G06V 10/26; G06V 10/764; G06V 10/98; G06V 20/52; G06V 20/653

(57) ABSTRACT

A device, system and method for improving weapon detection for scenarios in which an object obscures detection of an object of interest are described. An image sensor detects a first object that obstructs identification of an object of interest. The image sensor and an object scanner identify a plurality of scan zones to check whether the object of interest is present. A scan sensitivity of the object scanner is adjusted based on a scan zone location and an expected size characteristic of the first object. An abnormality in scanned size or shape of the first object in one of the plurality of scan zones is determined based on the scan sensitivity. Existence of the object of interest is determined based on the abnormality.

### BACKGROUND OF THE INVENTION

Security in an emergency context may involve dangerous situations that are difficult to detect. For example, in an emergency room of a hospital, it can be very challenging to detect the existence of weapons on patients requiring emergency medical assistance. Moreover, it is possible that a weapon held by an emergency room patient may be difficult to detect because such weapon detection by weapon scanners may be obstructed by a large object such as a gurney, wheelchair, or crutches. A method or system to detect and identify such surreptitiously transported weapons past a security checkpoint could improve the security of emergency rooms with respect to clandestine weapons possessed by emergency victims.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts example user interfaces of a video analytics based system for weapon detection, in accordance with some examples.

FIG. 2 depicts an example workflow with an image sensor and object scanner to detect weapons at a security checkpoint at a healthcare facility, in accordance with some examples.

FIGS. 3-4 illustrate zone based weapon detection with an example system comprising an image sensor and object scanner, in accordance with some examples.

FIG. 5 illustrates a block diagram of an example electronic device, in accordance with some examples.

FIG. 6 depicts an example camera device, in accordance with some examples.

FIGS. 7A-7B each illustrate an example security ecosystem comprising a plurality of camera devices, in accordance with some examples.

FIG. 8 is a flowchart of a method for video analytics based augmented weapon detection, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

It may be challenging to detect weapons carried into a healthcare facility by a patient using a hardware apparatus that could obstruct weapon detection. For example, when a patient is being brought in an emergency room or critical care area of the healthcare facility in an emergency medical situation, an object scanner at a security checkpoint area of the healthcare facility may miss detection of weapons that the emergency healthcare patient is bringing into the healthcare facility. For example, the patient may be brought into the emergency room on a gurney, wheelchair, or with crutches, and when the patient walks through a conventional metal detector or other object scanner, the object scanner may not alert to a gun, knife, or weapon possessed by the patient because the weapon's detection is blocked by the larger hardware apparatus (gurney, wheelchair, crutches, etc.).

Although some weapons carried in by emergency healthcare patients or other parties to the healthcare facility may fortunately be resolved without incident, this is not always the case. A weapon whose presence is not detected when it is brought into the healthcare facility may result in injury or death, such as by the patient possessing the weapon attacking personnel or other inhabitants present in the healthcare facility. It may be desirable to improve such weapon detection, especially in emergency healthcare facilities, to improve the safety of healthcare facilities and other areas where it is desirable to improve weapon detection for ensuring safety and security.

The present disclosure provides a technical solution to the particular technical challenges of detecting weapons that are being impermissibly smuggled past a security checkpoint described herein. In particular, metal and other object scanners may not alert to the presence of certain weapons whose presence or existence is being blocked by the existence of a larger hardware apparatus. For example, a weapon may be clandestinely carried across the security checkpoint by being embedded or otherwise blocked with respect to operation of the object scanner by the larger hardware apparatus. The object scanner in conjunction with an image sensor (e.g., video camera) may use the disclosed technical solution to distinguish between the larger hardware apparatus and any weapon that may be present for weapon detection at the security checkpoint. In this way, weapon detection and security can be improved, especially in the emergency medical healthcare context.

The weapon detection of the present disclosure may employ machine learning, artificial intelligence, or an appearance search to correlate the sensed hardware apparatus by the video camera with known types of hardware apparatus. That is, video analytics can be used to determine what type of hardware apparatus has been detected, such as wheelchair, gurney, or crutch. This determination may include analysis of the shape, size, density, location etc. of the structure (e.g., metal structure) of the hardware apparatus. Based on the determined type of hardware apparatus by the video camera, a scan sensitivity of the object scanner can be adjusted. For example, a metal scan sensitivity can be adjusted based on an expected size for each location of the hardware apparatus. As an example, if the hardware apparatus is a gurney, then scan sensitivity can be adjusted such that: there is low sensitivity from below (e.g., along the z-axis) the gurney bed, high sensitivity from above the gurney bed, and high sensitivity near the head and foot area of a patient on the gurney bed.

As described through the present disclosure, the disclosed weapon detection will improve detection of weapons or items of interest whose detection would otherwise be obscured by the hardware apparatus. As such, the present disclosure addresses technical challenges in visual object detection by sensors (e.g., image sensor) and/or scanners by reducing both instances of false positives and false negatives otherwise resulting from the presence of larger hardware apparatus that interfere with detection of an object of interest. In particular, the present disclosure provides a technical solution that improves identification of expected hardware (e.g., wheelchair, gurney, crutches) compared to unexpected hardware (e.g., possible weapon). The present disclosure can identify areas of unexpected, asymmetric or inconsistent sizes or densities (e.g., greater than expected) relative to the expected hardware as determined by the scanner in order to identify possible weapons or objects of interest. Furthermore, the disclosed system can learn to identify specific models of hardware apparatuses to improve the filtering of expected from unexpected hardware.

According to one embodiment of the present disclosure, a computer-implemented method for improving weapon detection for scenarios in which an object obscures detection of an object of interest. The method includes detecting, via an image sensor, a first object that may obstruct identification of an object of interest. The method includes identifying, by the image sensor and an object scanner, a plurality of scan zones to check whether the object of interest is present. The method includes adjusting, based on a scan zone location and an expected size characteristic of the first object, a scan sensitivity of the object scanner for each of the plurality of scan zones. The method includes determining, based on the scan sensitivity, an abnormality in scanned size or shape of the first object in one of the plurality of scan zones. The method includes determining, based on the abnormality, an existence of the object of interest.

According to one embodiment of the present disclosure, a system is provided including a processor configured to perform a method for improving weapon detection for scenarios in which an object obscures detection of an object of interest is provided. The system includes: a video camera configured to visually identify a first object; an object scanner configured to scan for a presence of an object of interest; and the processor operatively in communication with the video camera and the object scanner. The method includes detecting a first object that obstructs identification of an object of interest. The method includes determining a known shape or size of the first object. The method includes detecting, by the image sensor and the object scanner, a plurality of scan zones to check whether the object of interest is present. The method includes adjusting, based on a scan zone location and the known shape or size of the first object, a scan sensitivity of the object scanner for each of the plurality of scan zones. The method includes determining, based on the scan sensitivity, an abnormality in scanned size or shape of the first object in one of the plurality of scan zones along an axis of a three dimensional Cartesian coordinate system. The method includes determining, based on the abnormality, a presence of the object of interest along the axis.

According to one embodiment of the present disclosure, a object detection device including a processor and a computer-readable storage medium is provided including instructions (e.g., stored sequences of instructions) that, when executed by the processor, cause the object detection device to perform a method for improving weapon detection for scenarios in which an object obscures detection of an object of interest. The method includes detecting, via an image sensor component, a first object that obstructs identification of an object of interest. The method includes identifying, by the image sensor component and an object scanner component, a plurality of scan zones to check whether the object of interest is present The method includes adjusting, based on a scan zone location and an expected size characteristic of the first object, a scan sensitivity of the object scanner component for each of the plurality of scan zones. The method includes determining, based on a machine learning model, a type of the first object. The method includes determining, based on the scan sensitivity, an abnormality in scanned size or shape of the first object in one of the plurality of scan zones. The method includes determining, based on the type of the first object and the abnormality, an existence of the object of interest.

Each of the above-mentioned embodiments will be discussed in more detail below, starting with example system and device architectures of the system in which the embodiments may be practiced, followed by an illustration of processing blocks for achieving an improved technical communication or data processing based method, device, and system for supporting rescue efforts in a building collapse scenario.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the drawings.

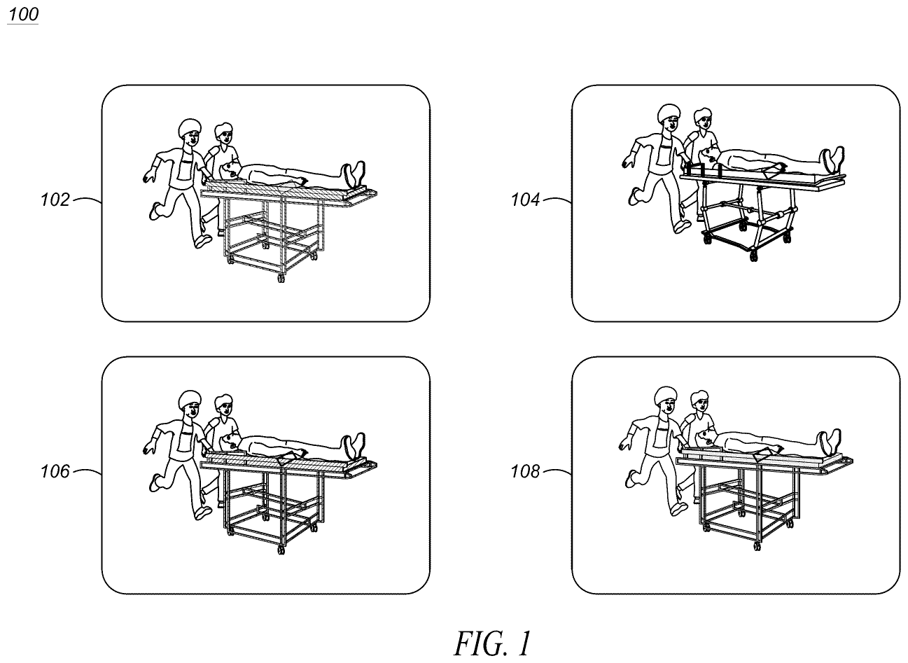

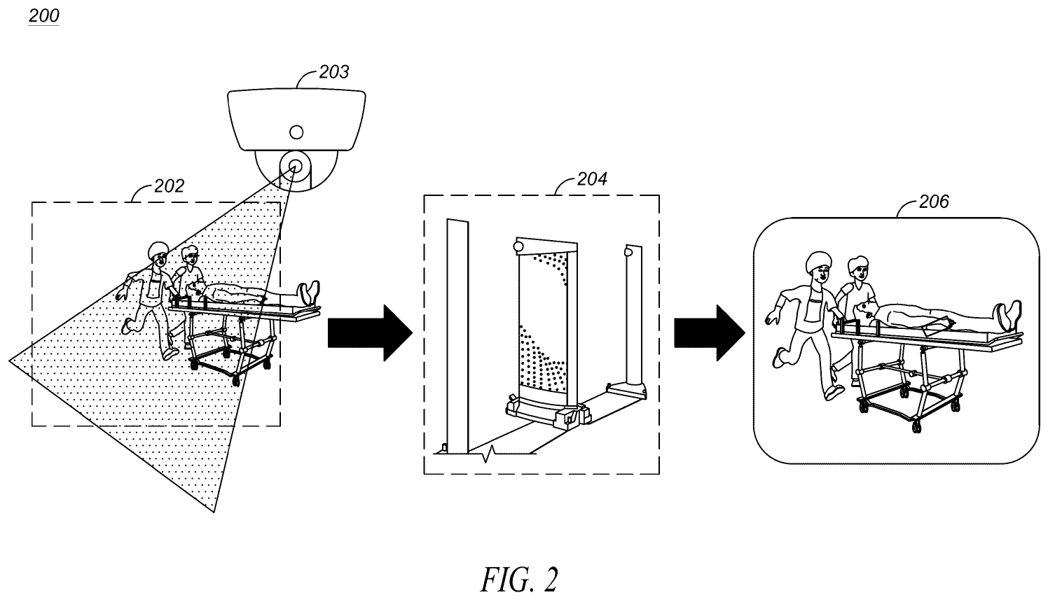

FIG. 1 depicts example user interfaces of a video analytics based system 100 for weapon detection, in accordance with some examples. The video analytics system can comprise an image sensor and object scanner (shown in FIG. 2). The video analytics system 100 can be configured to detect objects of interest such as for weapon detection at a security checkpoint. As an example, the video analytics system 100 may be implemented into an emergency healthcare facility as a security system that identifies weapons being impermissibly brought into the emergency healthcare facility. When people or figures approach the video analytics system 100, the image sensor (e.g., video camera) may identify hardware apparatuses such as wheelchairs, gurneys, and crutches. In particular, when performing object detection, the video analytics system 100 can distinguish between the presence of hardware apparatuses with objects of interest such as weapons (e.g., knives, guns, etc.).

The video analytics system 100 can identify the presence and location of objects of interest or weapons even when their presence is obstructed by co-located hardware apparatuses. For example, the video analytics system 100 may indicate the presence of a weapon even when the weapon is located on a wheelchair or gurney, such as depicted in the example user interfaces of FIG. 1. The video analytics system 100 can generate an alert (such as by the object scanner) when the presence of the weapon (or object of interest) is detected. The location of the weapon may be indicated on a display, such as illustrated by a bounding box graphical element shown in the user interfaces 104, 106, 108. As an example, the bounding box graphical element may appear as a red box encompassing the detected weapon.

This may be advantageous because conventional weapon detection sensors may be unable to detect the existence of weapons that are obscured or appear embedded in a hardware apparatus. The user interface 102 illustrates how the depicted gurney and weapon may be difficult to see and/or detect. As an example, the depicted gurney and weapon can appear indistinguishable to a user such as due to appearing as the same color or pattern on the user interface 102. In particular, the bounding box surrounding a potential detected weapon or object of interest may appear difficult to perceive due to appearing similar to (e.g., camouflaged by) the larger hardware apparatus. In user interface 102, the user may see the bounding box as the same color and/or pattern as the rest of the gurney. Thus, a technical problem may arise because the user may be unable to distinguish the weapon from other hardware on the gurney. In contrast, the user interface 104, 106, 108 of the present disclosure clearly identifies expected hardware (e.g., hardware apparatus) versus unexpected hardware (e.g., possible weapon). For example, the user interface 104 can depict the hardware apparatus in a neon color to identify it and use green color to show metal densities determined by the object scanner (e.g., metal scanner).

Furthermore, the type of hardware apparatus can be identified by the video analytics based system 100, such as based on a machine learning (ML) or artificial intelligence (AI) model. As an example, the ML/AI model of the video analytics based system 100 can recognize whether the hardware apparatus is a wheelchair, a gurney, or crutches as well as what type or model of wheelchair, gurney, or crutches is detected. The known type and model of the hardware apparatus can be indicated visually on the user interface 104, for example, by a red color coding or a textual indication of what the hardware apparatus is. The user interfaces 106, 108 represent alternative displays that the user can use to visually identify, analyze, and otherwise interact with for weapon detection when the weapon would otherwise be obstructed from detection by the object scanner or image sensor of the video analytics system 100. For example, the user interfaces 106, 108 may enable to identify symmetries and inconsistencies in scanned size or density of the hardware apparatus.

That is, the user interface 106, 108 can indicate areas of a particular hardware apparatus in which the size, shape, density, and/or location of a specific area is unexpected, asymmetric, or otherwise inconsistent with what would be expected based on the scanned shape, size, or mass of the known hardware apparatus. As an example, these asymmetric or inconsistent regions or of the hardware apparatus can be highlighted visually, such as in colors (e.g., pink, yellow, etc.) on the display in which user interfaces 106, 108 are rendered.

Alternatively, other aspects of the hardware structure may be highlighted in different pink or yellow or other colors to identify expected sizes, structures, and densities corresponding to the detected hardware apparatus compared to unexpected or inconsistent shapes, structures, and densities. That is, the bounding box identifying a weapon or object of interest in user interfaces 106, 108 may appear in a different color, pattern, or other visual appearance compared to the remaining parts of the gurney/hardware apparatus. Advantageously, the user interfaces 104, 106, and 108 may highlight potential weapons or other items of interest otherwise obscured by the hardware apparatus, which is a capability that may reduce alerts for false positives and improve the efficiency of the video analytics system 100.

FIG. 2 depicts an example workflow with an image sensor and object scanner to detect weapons at a security checkpoint at a healthcare facility, in accordance with some examples. The image sensor 203 and object scanner 204 may be part of the video analytics based system 100. The image sensor 203 could be a digital camera, video camera, smartphone camera, or any type of suitable camera or visual medium sensor. The object scanner 204 can be a metal detector, nanowave detector, a thermal based object detector, a 360 degree scanner (e.g., capable of scanning top to bottom and at multiple scanning angles), an object scanner, or some combination or subcombination of the above. The object scanner 204 can be configured to detect the presence of metal or other material (e.g., graphite, carbon fiber, plastic), determine the density and size of subject matter being scanned (e.g., a patient on a hardware apparatus passing through the object scanner 204), and/or determine the identity of a particular object being scanned. In general, the object scanner 204 may be configured to determine expected material characteristics for the subject matter being scanned. As shown in FIG. 2, the image sensor 203 is capable of visually identifying the hardware apparatus being present, such as via object detection.

For example, as depicted by image 202, the image sensor 203 may detect a patient on a gurney being wheeled into a hospital past a security checkpoint by emergency medical personnel. The field of view of the image sensor 203 may include the patient lying on the gurney wheeled by hospital (or medical facility staff including emergency services or EMTs) such that the image sensor 203 can identify the gurney and visually recognize/search for the presence of weapons or any other objects of interest via an object detection algorithm. The processor of the image sensor 203 may receive and process structural model data of the various hardware apparatuses that the image sensor 203 may encounter. For example, the structure model data can include common hardware configurations of wheelchairs, gurneys, or crutches commonly used in medical facilities or medical contexts such that a shape identification and filtering function of the object detection algorithm is improved. As an example, the image sensor 203 can perform an appearance search to correlate a particular hardware apparatus (e.g., known model or type) with the output of the image sensor 203. That is, the image sensor 203 can associate each specific type of hardware apparatus with sensor data. For example, the image sensor 203 can determine the identity of the hardware apparatus (e.g., type, model, etc.) based on the known parameters (e.g., shape, structure, location, etc.) from the appearance search correlated with what the hardware apparatus should be.

Additionally or alternatively, the object scanner 204 may perform the structural model data analysis, identification, and filtering alone or in conjunction (e.g., while interoperating) with the image sensor 203. Moreover, the image sensor 203 can determine the identity of the hardware apparatus based on metal size (or scanned object size) for each scanned location determined by the object scanner 204 when in interoperation. As used herein, filtering may refer to the image sensor 203 and/or object scanner 204 being configured to filter expected hardware (e.g., gurney hardware apparatus) from unexpected hardware (e.g., dangerous weapon). This filtering and distinction can be indicated on the user interface 206 such as by a graphical user element, which may be a specific color (e.g., red color) or other visual aid (e.g., graphical bounding box that shows the size, shape, and location of the unexpected hardware/weapon. As described herein, the determination of filtering may be based on inconsistencies in size or density determined from scans by the object scanner 204. The scanned material may be metal (e.g., aluminum) or some other material (e.g., wood).

The object scanner may be programmed with or learn via ML/AI what the expected size should be for each part of a particular model of hardware apparatus in order to detect such inconsistencies or asymmetries in expected scanned size. To this end, the scan sensitivity of the object scanner 204 can be adjusted based on what size would be expected to be measured by the object scanner 204. This adjustment in sensitivity by the object scanner 204 may be based on interoperation with the image sensor 203, which can sense and analyze the size, shape, density, and location of the hardware apparatus. As an example, the sensed shape can be used to determine the particular model and type of hardware apparatus being brought through the object scanner 204 as well as what size would be expected for the shape and/or location of the hardware apparatus currently being scanned by the object scanner 204. For example, if the hardware apparatus has the shape of crutches, the scan sensitivity may be decreased because the hardware apparatus is determined to be crutches that are relatively not dense. This addresses a conventional issue in which the detection threshold is not triggered for a weapon obscured by the hardware apparatus. By dynamically adjusting the scan sensitivity for the particular known hardware apparatus, weapon and object detection can be improved.

As another example, the scan sensitivity of the object scanner 204 may be increased because based on image sensor data, the hardware apparatus is determined to be a gurney being pushed through along the y-axis at a location corresponding to a head and foot area of a patient lying on the gurney. Accordingly, based on the current size, shape, density, and/or location determined by the image sensor 203, when the object scanner 204 scans below the bed of the gurney (e.g., along the z-axis), the scan sensitivity may be set as relatively low. Conversely, when the object scanner 204 scans above the gurney bed about the z-axis, the scan sensitivity can be set as relatively high. This advantageously enables the object scanner 204 to better determine one or more abnormalities in scanned size and/or shape for one or more portions of the hardware apparatus being scanned. In other words, the object scanner 204 may scan through multiple scan zones with adjustments in scan sensitivity based on image sensor data such that object detection of obscured objects is improved.

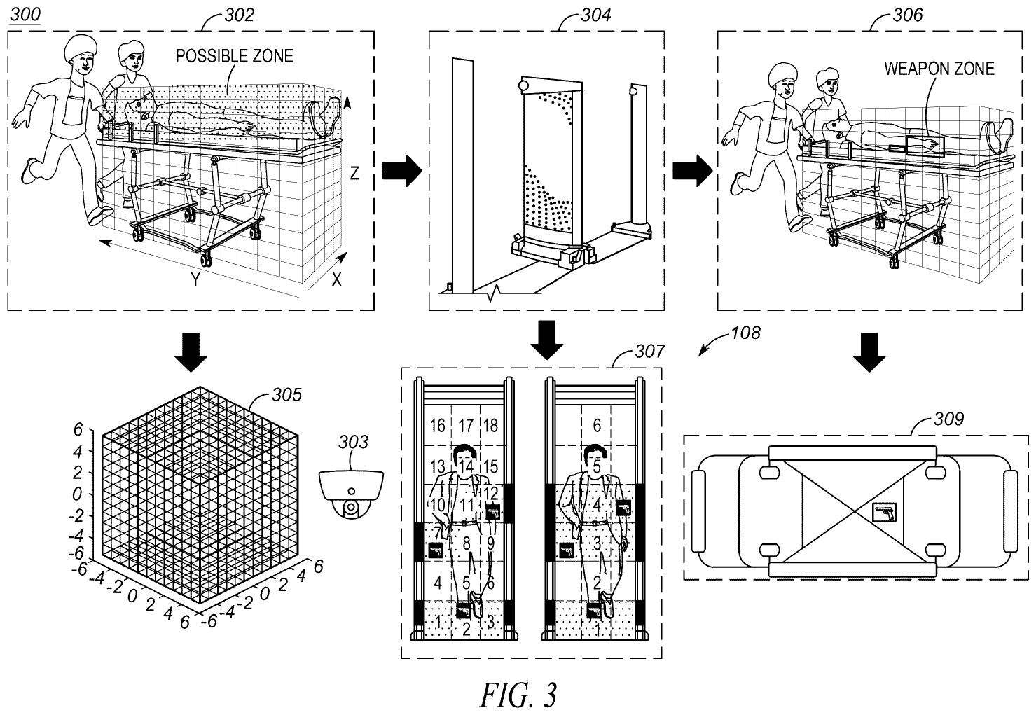

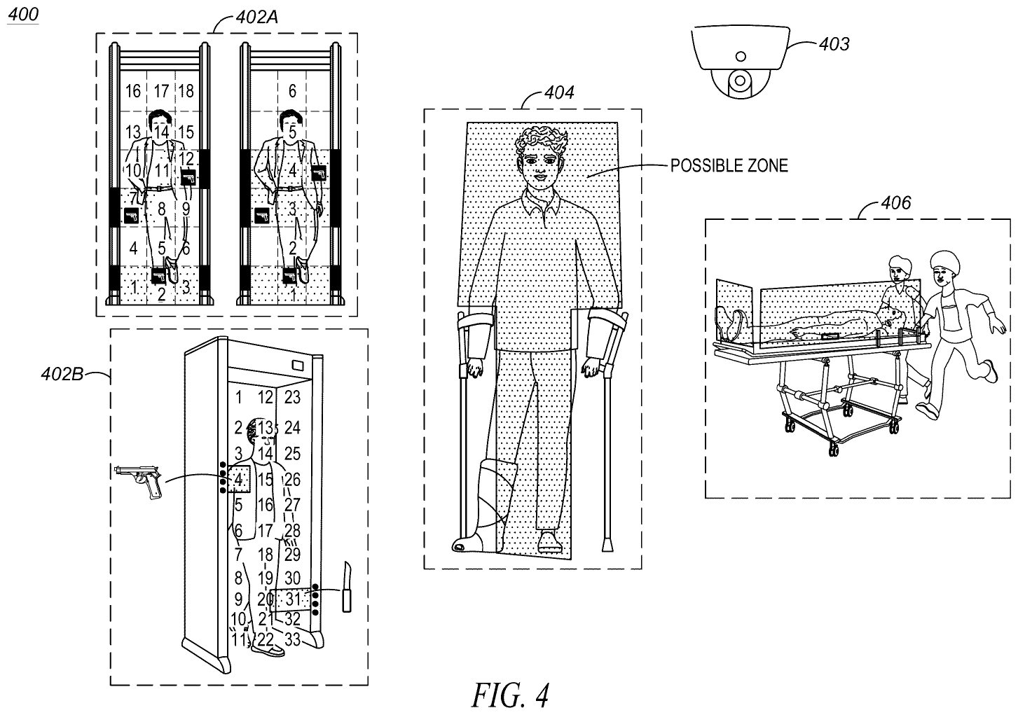

FIGS. 3-4 illustrate zone based weapon detection with an example system comprising an image sensor 303 and object scanner 304, in accordance with some examples. In the workflow 300, the step 302 illustrates individuals (e.g., emergency medical staff) pushing a hardware apparatus (e.g., gurney) through a security checkpoint of a medical facility (e.g., emergency medical services or ER checkpoint). At the security checkpoint, the zone based weapon detection system of the present disclosure can determine a plurality of voxels to label scan zone candidates in a three dimensional space. As depicted by image 305, an image sensor 303 (e.g., video camera) can use captured video data to divide the area in the vicinity of the hardware apparatus into voxels. For example, the area above and below the gurney in image 305 can be divided into voxel cubes (e.g., the three dimensional object recognized by video camera analytics can be virtually split into 3D cubes).

The voxels in image 305 may be used by the disclosed weapon detection system for labeling possible scan zone candidates of interest. The possible scan zone candidates can be identified in conjunction with adjusted scan sensitivity in order for the object scanner to detect weapons and other objects of interest that may be obscured by the hardware apparatus. Based on the known parameters (e.g., shape, size, density, or location) determined by the image sensor 303, the sensitivity of the object scanner can be adjusted and voxels or bounding boxes in image 305 with unexpected abnormalities can be flagged. The voxels in the image 305 are three dimensional counterparts to pixels that each represent a value on a grid in a three dimensional space, such that each voxel appears as a cube in the three dimensional (3D) Cartesian coordinate system depicted in image 305. As shown in step 302, a possible zone of interest can be detected by the image sensor 303. The image sensor 303 (or object scanner 304 or other computation component of the example system) can section the entire 3D Cartesian area (the entire volume about the gurney/hardware apparatus illustrated by the X, Y, and Z axis) in order to label a possible zone, such as the zone above the gurney shown in step 302 of FIG. 3.

As the image sensor 303 analyzes the hardware structure with programmed video analytic or ML/AI algorithm, the image sensor 303 can evaluate the possible zones based on known data of the hardware apparatus. As an example, the image sensor 303 (or in combination with the object scanner 304) can analyze the size, shape, density, and location of the hardware apparatus, such as the known metal structure of the gurney support structure, the gurney bed, and the like. In this way, the image sensor 303 can interoperate with the object scanner 304 to adjust the scan sensitivity of the object scanner 304. As described herein, the object scanner 304 may be configured to scan and identify metal via metal densities or alternatively may be a different type of density detector such as an x-ray detector or nanowave detector. In this way, the object scanner 304 may be configured to determine densities of objects that are metal and other objects which are not metal.

Moreover, the object scanner 304 and image sensor 303 may interoperate to adjust the size of scan zone areas such as six by four voxels, three by three voxels, and or the like. That is, the dimensions of a target scan area can be adjusted based on the known shape, size, density, and location of the hardware apparatus and/or the measured density in the metal zones. In general, the video analysis performed by the image sensor 303 and the known structure of the detected hardware apparatus may be used to improve weapon/object detection by the object scanner 304 based on dynamically changing the scan sensitivity applied by the object scanner 304 as it determines object densities for identifying objects of interest.

As an example, the object scanner 304 may be a metal detector scanning in one or more directions along the 3D Cartesian coordinate system (e.g., along Y-axis) as personnel slowly push the gurney through the object scanner 304 depicted in step 304. Accordingly, in step 304, the object scanner 304 can identify areas of the scanned volume that contain metal. The image 307 is an example of this process which depicts the object scanner 304 identifying via color coding or other visual indication which areas on a 2D plane have metal. Areas that have objects of interest such as a weapon can be highlighted on the 2D plane shown in image 307. For the example of the medical patient lying on the gurney, the detection of weapons possessed by the person by the object scanner 304 can be obstructed by the high metal size of the gurney. When the image sensor 303 is used in combination with the object scanner 304, the operation of the object scanner 304 can ignore alerts of detected metal when they involve detection of metal that is expected because the detected metal is part of the gurney. Some or all of the functionality described herein performed by the image sensor 303 or object scanner 304 could also be performed by the combination of image sensor 303 and object scanner 304, or performed by a separate computation component (e.g., electronic computing device), which can be located remotely to the image sensor 303 and/or object scanner 304.

Similarly, the object scanner 304 can adjust its scan sensitivity such that it only generates an alert that indicates the potential presence of a weapon when an abnormality in scanned density or shape is detected. To this end, the object scanner 304 can label density or size zones as the gurney is pushed through to complete the scanning along the selected direction. As an example, the object scanner 304 can identify metal zones along the scanned volume (e.g., as depicted in image 307) based on the scanned density or size measurements. While interoperating with the image sensor 303, the object scanner 304 may identity metal zones in which the measured metal size of the metal zone is abnormal or unexpected given what the expected size of the known metal hardware apparatus (e.g., gurney) should be for the location of the particular metal zone being evaluated. As an example, if the object scanner 304 determines there is a metal zone above the mattress of the gurney and the measured metal size is expected according to the expected metal size of a metal bar of the gurney, then the object scanner 304 may determine that no weapon is detected. However, if the measured metal size is abnormal or unexpected even given the presence of other innocuous metal such as a cell phone, then the object scanner 304 may determine that a weapon is detected.

For example, the weapon may be a gun which is very dense in metal, such that the object scanner 304 can generate an alert based on the abnormal, unexpected, or asymmetric measured metal size or density associated with a location of a metal zone relative to the known structure of the gurney/hardware apparatus. Therefore, the zone based weapon detection system of the present disclosure improves the detection of weapons and other objects of interest, especially in an obstructed emergency context (e.g., emergency medical context). As described herein, the dynamic change to the scan sensitivity of the object scanner 304 may be performed based on the video analytics of the image sensor 303 of the hardware apparatus' known metal structure.

For example, if the hardware apparatus is crutches, then the scan sensitivity for metal density (or size) in the area of interest can be increased because the crutches have a relatively small size. Increasing the scan sensitivity enables better detection of smaller pieces of metal. The scan sensitivity should be appropriate to detect if a gun is being brought through the object scanner 304. As an example, the scan sensitivity may be highest above the gurney bed, lower scan sensitivity below the gurney bed but above the lower frame of the gurney, and even lower sensitivity below the lower frame.

As an example, if the hardware apparatus is a gurney, then the scan sensitivity for metal size can be adjusted to be high sensitivity when scanning the head and foot area of the gurney as scanning along the y-axis occurs. As an example, if the hardware apparatus is a gurney and scanning along the z-axis occurs, then the scan sensitivity for metal size can be adjusted to be low sensitivity when scanning below the gurney bed and high sensitivity when scanning above the gurney bed. As an example, if the hardware apparatus is crutches, the scan sensitivity for size can be adjusted to be higher sensitivity at the middle band of the crutches compared to the sides. As an example, if the image sensor 303 detects an object that interferes with scanning such as wrist watch or necklace by a patient, the object scanner 304 may interoperate to reduce scan sensitivity of those zones with interfering objects and increase the sensitivity for other zones.

Accordingly, the scan sensitivity for the object scanner 304 can be iteratively adjusted as the object scanner 304 moves from one particular scan zone location to another. Although the description above describes operation based on metal size, similar operations could be performed with measured size values of other objects that are not metal. As shown in FIG. 3, step 306 depicts the identification and rendering of one or more weapon zones based on the labeled metal zones by the object scanner 304. Each weapon zone may be identified as a bounding box in a 3D reconstructed dimension. At step 306, a weapon zone indicating the presence of a weapon such as a knife appears near the hand of a patient lying down on the gurney. Based on the adjusted scan sensitivity, the object scanner 304 may generate a bounding box that identifies the metal of the corresponding weapon zone as distinguishable from the detected metal of the hardware apparatus.

The weapon zones may be visually rendered on a user interface such as the user interface 309 rendered on an electronic display. The user interface 309 may advantageously more clearly identify objects that are not part of the hardware apparatus and therefore better highlight the presence of identified objects that may be weapons and which might otherwise have been obscured by the hardware apparatus. To this end, the user interface 309 may depict an example scan by the object scanner 304 (e.g., from above, below, front, back etc.) that identifies items or shapes that are unexpected, asymmetric, or otherwise inconsistent with the shape and structure of the known hardware apparatus in terms of positioning or size. The object scanner 304 may apply an algorithm such as a AI/ML algorithm to learn about what type and model of each instance of the hardware apparatus is. That is, for example, the object scanner 304 may learn to identify specific models of gurneys, crutches, and wheelchairs to improve filtering of hardware from objects that may be weapons.

In the illustration 400, another example of the image sensor 403 performing video analytics to visually section visual data into a plurality of voxels to label possible scan zone candidates in a three dimensional space (e.g., XYZ Cartesian space). As described herein, the possible scan zone candidates are combined with metal detector data from the object scanner 402A-402B. In the illustration 400, the object scanner 402A-402B can determine metal zones based on identified metal along the y-axis for an individual walking through the object scanner 402A-402B. For example, the individual may be a patient walking through a checkpoint of a medical facility such that the object scanner 402A-402B can detect metal for the presence of weapons such as guns and knives and can identify labeled (e.g., indexed by number) metal zones along the depicted 2D plane for this purpose.

However, when the patient walks through the checkpoint with a hardware apparatus such as crutches, the weapon detection by the object scanner 402A-402B may be obscured by the weapon detection of the larger crutches. Accordingly, the object scanner 402A-402B and image sensor 403 may interoperate for adjusted scan sensitivity to determine possible scan zones where an abnormality in scanned size or shape exists. As an example, the image 404 illustrates that the possible scan zone(s) are determined to be about the patient's person away from the physical presence of the crutches. Similarly, the image 406 shows the determination of possible scan zone(s) above the depicted gurney bed where an abnormality in measured size can be determined.

Moreover, the object scanner 402A-402B and image sensor 403 may interoperate to adjust the size of scan zone areas such as six by four voxels, three by three voxels, and or the like. That is, the dimensions of a target scan area can be changed or adjusted based on the known size or shape of the hardware apparatus and/or the measured density in the metal zones. On an example user interface, the possible scan zone(s) may appear visually in green while any detected weapon may appear in red in a bounding box on the user interface display. As the gurney is pushed through in image 406, metal detection may indicate an abnormality as an asymmetry in measured size or density. That is, metal detection may indicate that one side of the gurney is more dense than another side such that a gun may be present on the patient's body. The adjusted scan sensitivity for a particular target scan zone may be used to determine this asymmetry in a way that is unobstructed by the presence of the larger hardware apparatus. The adjustments to scan sensitivity can be iteratively applied along the whole shape of the scanning area so that the adjustments can be different depending on scan location. In this way, the disclosed system may improve detection of an object whose detection might otherwise be impeded or obstructed by another object.

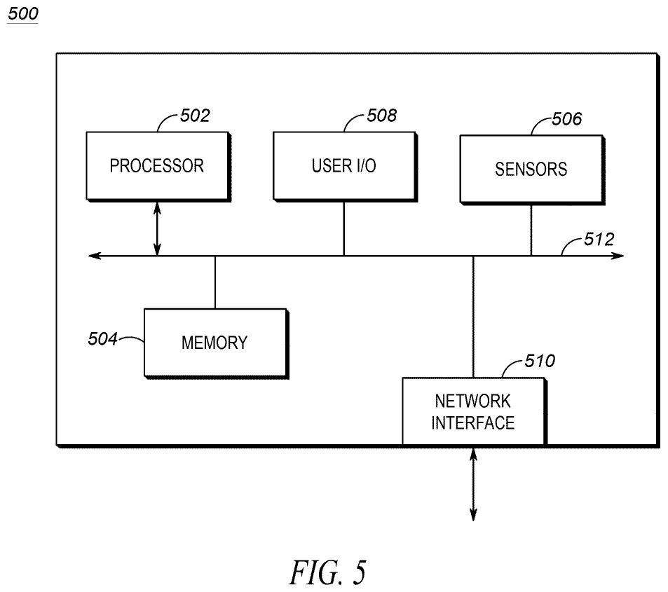

FIG. 5 illustrates a block diagram of an example electronic device, in accordance with some examples. In some embodiments, the computer device 500 may be a personal device, such as a UE, or a network device, or other equipment used in the network environment). The computer device 500 may include a physical device and/or a virtual device, such as a server running one or more virtual network functions (VNFs) of a network. In various examples, the computer device 500 may be a processor, a specialized computer, a personal or laptop computer (PC), a tablet PC, a mobile telephone, a smartphone, a network router, switch or bridge, a circuit such as an application specific integrated circuit (ASIC) or field programmable gate array (FPGA), or any machine capable of executing instructions (sequential or otherwise) that specify actions to be taken by that machine. In some embodiments, the computer device 500 may be an internet-of-things (IoT) or a narrowband IoT (NB-IoT) device or other device embedded within other, non-communication-based devices such as appliances or vehicles. The computer device 500 may render the user interface 309 (or similar UIs) for providing improved object detection, especially in a context (e.g., emergency medical facility security checkpoint) where a large hardware apparatus obscures weapon detection at the checkpoint.

The computer device 500 may include various components connected by a bus 512. The computer device 500 may include a hardware processor 502 such as one or more central processing units (CPUs) or other processing circuitry able to provide any of the functionality described herein when running instructions. The processor 502 may be connected to a memory 504 which may include a non-transitory machine-readable medium on which is stored one or more sets of instructions. The memory 504 may include one or more of static or dynamic storage, or removable or non-removable storage, for example. A machine-readable medium may include any medium that is capable of storing, encoding, or carrying instructions for execution by the processor 502, such as solid-state memories, magnetic media, and optical media. The machine-readable medium may include, for example, Electrically Programmable Read-Only Memory (EPROM), Random Access Memory (RAM), or flash memory.

The instructions may enable the computer device 500 to operate in any manner thus programmed, such as the functionality described specifically herein, when the processor 502 executes the instructions. The machine-readable medium may be stored as a single medium or in multiple media, in a centralized or distributed manner. In some embodiments, instructions may further be transmitted or received over a communications network via a network interface 510 utilizing any one of a number of transfer protocols (e.g., frame relay, internet protocol (IP), transmission control protocol (TCP), user datagram protocol (UDP), hypertext transfer protocol (HTTP), etc.).

The network interface 510 may thus enable the computer device 500 to communicate data and control information (e.g., security information) with other devices via wired or wireless communication. The network interface 510 may include electronic components such as a transceiver that enables serial or parallel communication. The wireless connections may use one or more protocols, including Institute of Electrical and Electronics Engineers (IEEE) Wi-Fi 802.11, Long Term Evolution (LTE)/4G, 5G, Universal Mobile Telecommunications System (UMTS), or peer-to-peer (P2P), for example, or short-range protocols such as Bluetooth, Zigbee, or near field communication (NFC). Wireless communication may occur in one or more bands, such as the 800-900 MHz range, 1.8-1.9 GHz range, 2.3-2.4 GHz range, 60 GHz range, and others, including infrared (IR) communications. Example communication networks to which computer device 500 may be connected via network interface 510 may include a local area network (LAN), a wide area network (WAN), a packet data network (e.g., the Internet), mobile telephone networks (e.g., cellular networks), and wireless data networks. Computer device 500 may be connected to the networks via one or more wired connectors, such as a universal serial bus (USB), and/or one or more wireless connections, and physical jacks (e.g., Ethernet, coaxial, or phone jacks) or antennas.

The computer device 500 may further include one or more sensors 506, such as one or more of an image sensor, metal sensor, accelerometer, a gyroscope, a global positioning system (GPS) sensor, a thermometer, a magnetometer, a barometer, a pedometer, a proximity sensor, a door sensor, or an ambient light sensor, among others. The sensors 506 may include some, all, or none of one or more of the types of sensors above (although other types of sensors may also be present), as well as one or more sensors of each type. The sensors 506 may include metal sensors that can be configured to detect the presence of metal and/or image sensors that are configured to visually determine zones of interest. The sensors 506 may interoperate together such as to adjust a scan sensitivity from a default scan sensitivity. The sensors 506 may be used in conjunction with one or more user input/output (I/O) devices 508 to indicate, on a user interface dashboard, the presence of weapons or objects of interest at a security checkpoint. The user I/O devices 508 may include one or more of a display (e.g., a touch screen display of a mobile computing device), a camera, a speaker, a keyboard, a microphone, a mouse (or other navigation device), or a fingerprint scanner, among others. The user I/O devices 508 may include some, all, or none of one or more of the types of I/O devices above (although other types of I/O devices may also be present), as well as one or more I/O devices of each type.

The computer device 500 may include different specific elements depending on the particular device. For example, although not shown, in some embodiments, computer device 500 may include a front end that incorporates a millimeter and sub-millimeter wave radio front end module integrated circuit (RFIC) connected to the same or different antennae. The RFICs may include processing circuitry that implements processing of signals for the desired protocol (e.g., medium access control (MAC), radio link control (RLC), packet data convergence protocol (PDCP), radio resource control (RRC) and non-access stratum (NAS) functionality) using one or more processing cores to execute instructions and one or more memory structures to store program and data information. The RFICs may further include digital baseband circuitry, which may implement physical layer functionality (such as hybrid automatic repeat request (HARQ) functionality and encoding/decoding, among others), transmit and receive circuitry (which may contain digital-to-analog and analog-to-digital converters, up/down frequency conversion circuitry, filters, and amplifiers, among others), and RF circuitry with one or more parallel RF chains for transmit/receive functionality (which may contain filters, amplifiers, phase shifters, up/down frequency conversion circuitry, and power combining and dividing circuitry, among others), as well as control circuitry to control the other RFIC circuitry.

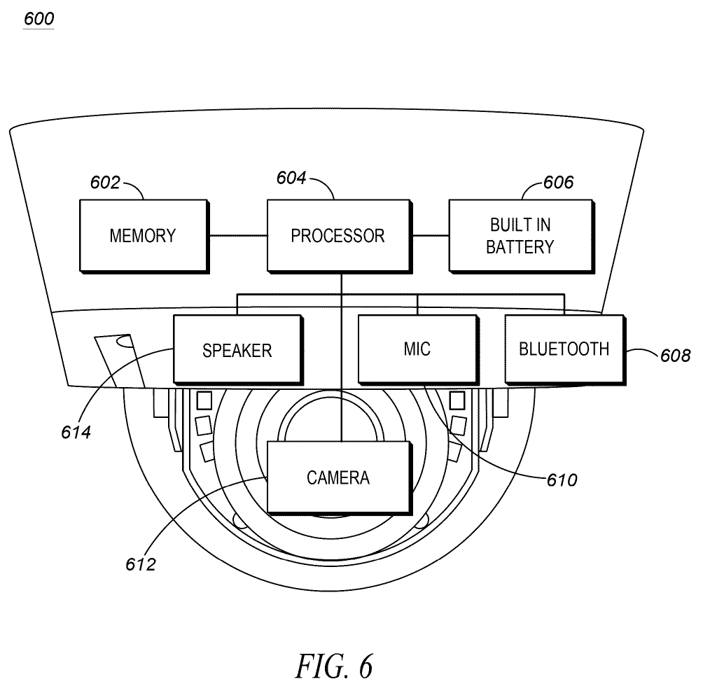

FIG. 6 depicts an image sensor such as a camera device 600, in accordance with some examples. The camera device 600 can have object detection capabilities such that it operates to identify and disambiguate between different objects. For example, the camera device 600 can be configured to identify and distinguish different types of weapons such as knives and guns. Similarly, the camera device 600 may be configured to detect and distinguish between hardware apparatuses such as gurneys, wheelchairs, crutches, and canes, such as for an emergency medical healthcare security checkpoint. As shown in FIG. 4, the camera device 600 is a video camera performing video analytics features (e.g., objection detection, appearance search, analysis) with components including a memory 602, a processor 604 operatively connected to the memory 602, a built in battery 606, a Bluetooth component 608, a microphone 610, an camera component 612, and a speaker 614.

The memory 602 can be configured to store data and be in operative communication with the processor 604 for executing various operations. The memory 602 may comprise volatile or non-volatile memory components, including but not limited to RAM (Random Access Memory), ROM (Read-Only Memory), flash memory, or any other suitable storage medium. The processor 604 is configured to control the operation of the camera device 600, process captured images and videos, store identity and other information about detected objects, execute other algorithms for analysis and detection, and manage communication with external devices. For example, the analysis performed by the processor 604 may include analysis of a structure of a detected object, such as analyzing the shape, density configuration, and location of the known metal structure of a particular hardware apparatus. The built in battery 606 of the camera device 600 may ensure uninterrupted operation and enhanced mobility. The built in battery 606 stores power and provides power to the various components of the camera device 600. In this way, the camera device 600 does not have to be plugged in at all time; that is, the camera device may function independently of external power sources for extended periods. The built in battery 606 may be rechargeable and designed to withstand frequent charging cycles for prolonged usage in video surveillance.

The Bluetooth component 608 can support wireless connectivity via short-range wireless communication (e.g., 2.4 GHz ISM frequency band) with compatible devices by the video camera device 600. The Bluetooth module 608 may enable seamless pairing with smartphones, tablets, or other Bluetooth-enabled computing/communication devices, allowing users to remotely access and control the camera device 600. Moreover, Bluetooth connectivity provided by the Bluetooth component 608 can facilitate data exchange, configuration, firmware updates, and other ad-hoc communication based capabilities. Although the camera device 600 is described as comprising the Bluetooth component 608, any other suitable wireless or wired communication method/component is also contemplated by the present disclosure. For example, the camera device 600 can use other wireless technology modalities such as Wi-Fi, Zigbee, RFID, Infared (IR communication), or Near Field Communication (NFC). As understood in the art, Wi-Fi may operate based on IEEE 802.11 standards allowing devices to communicate through access points, Zigbee may enable low-power wireless communication, RFID may enable wireless identification and tracking of objects via radio frequency (RF) signals, IR may enable wireless data communication with IR waves, and NFC may enable very short range wireless communication (e.g., devices in close proximity).

The camera device 600 also comprises a microphone 610 and speaker 614 suite to facilitate two-way audio communication. The speaker 614 can perform playback of audio signals, including alerts, notifications, and voice messages. For example, as discussed herein, the speaker 614 can generate an audible alert indicating the presence of a dangerous weapon, situation, or other object of interest. The microphone 610 captures ambient sounds and user-generated audio inputs. For example, the microphone 610 can capture audio response (e.g., human natural language for audio controlled commands) from users. The microphone 610 and speaker 614 may provide interactive capabilities for the camera device 600, enabling real-time communication between users and monitored areas, for example.

The camera component 612 may be a suitable high-resolution camera capable of capturing clear and detailed images and videos. As an example, the camera component 612 can utilize advanced imaging technology, including but not limited to CMOS (Complementary Metal-Oxide-Semiconductor) sensors, lenses, and image processing algorithms, to perform its image capture functionality for video capture and/or surveillance. The camera component 612 can have adjustable settings for resolution, frame rate, and exposure, such that it adapts to various lighting and environmental conditions to achieve optimal image quality and coverage.

As discussed herein, the video camera device 600 may be a video camera for capturing video footage of a specific area for surveillance or monitoring purposes.

The video camera device 600 may include an image sensor used to convert light into electronic signals to capture images or video frames on the sensor's surface. The video camera device 600 can be configured to perform processing, analysis, and other manipulation of images or videos that it has captured. Accordingly, the video camera device 600 can identify characteristics of detected objects such as hardware apparatuses such that the video camera device 600 can interoperate with an object scanner to adjust the object scanner's scan sensitivity based on the identified characteristics. This may improve detection because a default fixed scan sensitivity of the object scanner may not alert for certain situations such as when one object obscures detection of another object. The video camera device 600 may be programmed to analyze metal identified in a bounding box differently because the adjusted scan sensitivity facilitates detection of an abnormality within the bounding box. As an example, the video camera device 600 could identify the abnormality because a patient on two crutches has a left crutch with more density or an asymmetric density relative to the other side or vice versa.

The video camera device 600 may perform analog to digital conversion (A-D conversion) of a captured analog video signal, transmission (e.g., real-time transmission over coaxial or Ethernet cables or wirelessly to a monitoring station or recording/storage medium), and control and monitoring. For example, the video camera device 600 can have features such as pan, tilt, zoom (PTZ) functionality, motion detection, night vision (infrared illumination), and remote access for configuration and viewing via computer software, mobile apps, or web browsers. Video footage or analysis from the video camera device 600 or any other cameras connected to it can be stored for later viewing, analysis, or archival purposes.

The video camera device 600 may be connected to multiple other cameras or devices in a network, such as one that forms a security ecosystem as described herein. In this way, the security ecosystem can monitor multiple or broader areas for surveillance and monitoring. Furthermore, the video camera device 600 may perform various video analytics algorithms which may or may not include ML/AI aspects. As an example, the video camera device 600 can perform various computer vision techniques for object detection (e.g., identifying and locating objects of interest within video footage in real-time or offline). An example video object detection algorithm includes capturing an input video stream over time from a camera feed, pre-processing the frame to improve accuracy (e.g., resizing, normalization, noise reduction, color space conversion, etc.), object detection (e.g., using convolutional neural networks (CNNs) for recognizing objects by learning hierarchical features), feature extraction (e.g., to identify colors, textures, shapes and other visual characteristics for object recognition), object localization (e.g., with bounding boxes), classification, post-processing to refine results and improve accuracy, and output visualization. As an example, the video camera device 600 can be configured to apply machine learning to learn specific models of hardware apparatus to improve filtering and weapon detection over time. It will be understood that other suitable algorithms can be performed by the video camera device 600.

For example, the video camera device 600 may perform video analytics on input video camera data via preprocessing, feature extraction, event detection (e.g., detecting motion, tracking objects, recognizing gestures, identifying anomalies), object recognition, pattern recognition, and contextual understanding. As an example, the video camera device 600 could send video analytics data to an object scanner so that the object scanner can adjust its size or density scan sensitivity. For example, if the object being scanned at a given location is expected to be of large size or density (e.g., above a threshold), then the scan sensitivity can be set as lower. Conversely, if the object being scanned at the given location is expected to be of lower size or density (e.g., below the threshold), then the scan sensitivity can be set as higher. In this way, the object scanner can distinguish between an obscuring hardware apparatus and a weapon or object of interest. For example, the adjusted scan sensitivity may enable the object scanner to detect the presence of a gun whose detection would otherwise be impeded by the presence of larger obscuring crutches.

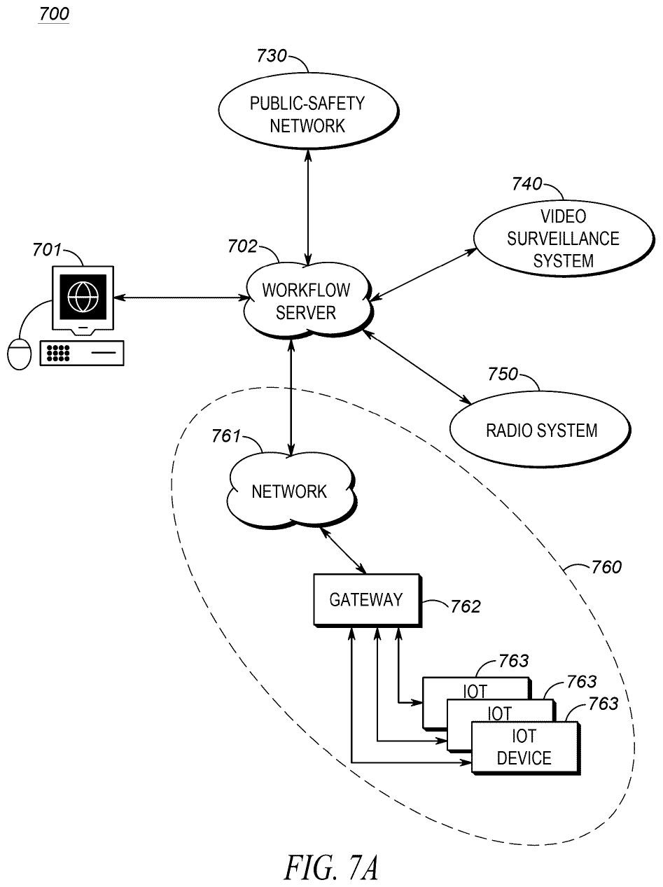

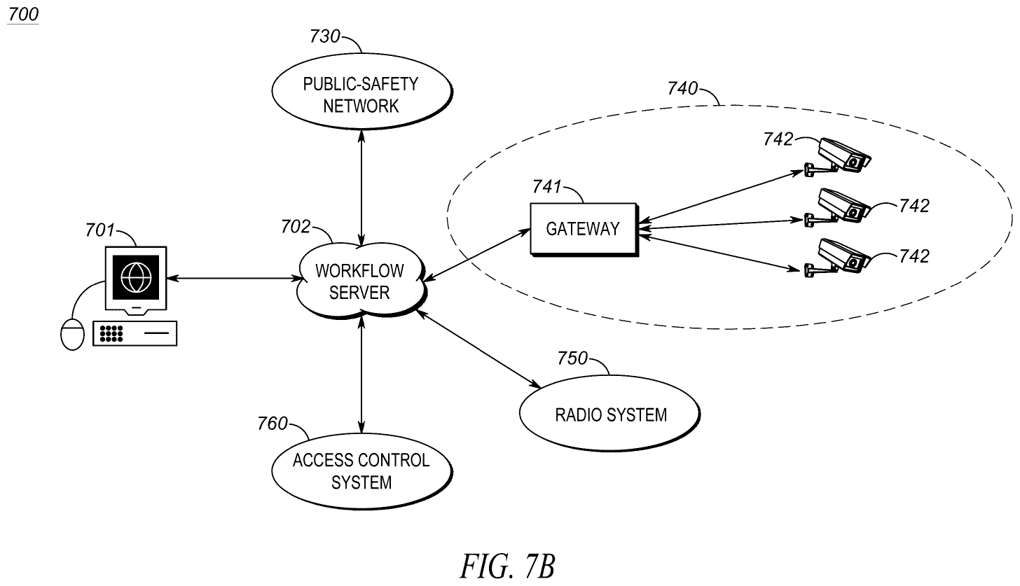

FIGS. 7A-7B each illustrate a security ecosystem 700 comprising a plurality of camera devices, in accordance with some examples. FIG. 7A illustrates the security ecosystem 700 capable of configuring and automating workflows across multiple systems. As shown, the security ecosystem 700 comprises a public-safety network 730, a video surveillance system 740, a private radio system 750, and an access control system 760. The workflow server 702 is coupled to each system 730, 740, 750, and 760. The workstation 701 is shown coupled to the workflow server 702, and is utilized to configure server 702 with workflows created by a user. It should be noted that although the components in FIG. 5 are shown geographically separated, these components can exist within a same geographic area, such as, but not limited to a building, a school, a hospital, an airport, a sporting event, a stadium, etc. It should also be noted that although only the networks and systems 730-760 are shown in FIG. 5A, one of ordinary skill in the art will recognize that many more networks and systems may be included in ecosystem 700. Alternatively, some elements of the security ecosystem 700 may be omitted, such as the public-safety network 730 and the private radio system 750.

The workstation 701 is preferably a computer configured to execute dispatch and incident management software. As will be discussed in more detail below, the workstation 701 is configured to present a user with a plurality of triggers capable of being detected by the network and systems 730-760 as well as present the user with a plurality of actions capable of being executed by the network and systems 730-760. The user will be able to create workflows and upload these workflows to the workflow server 702 based on the presented triggers and actions. The workflows may define actions and triggers relative to weapon detection in a medical context.

The workflow server 702 is preferably a server running a command center software and platform. The workflow server 702 is configured to receive workflows created by the workstation 701 and implement the workflows. Particularly, the workflows are implemented by analyzing events detected by the network and systems 730-760 and executing appropriate triggers. For example, assume a user creates a workflow on the workstation 701 that has a trigger comprising the surveillance system 740 detecting a weapon detection event, and has an action comprising notifying radios within the public-safety network 730. When this workflow is uploaded to the workflow server 702, the workflow server 702 will notify the radios of any weapon detection event detected by the surveillance system 740.

The public-safety network 730 is configured to detect various triggers and report the detected triggers to the workflow server 702. The public-safety network 730 is also configured to receive action commands from the workflow server 702 and execute the actions. In one embodiment of the present invention, the public-safety network 730 comprises includes typical radio-access network (RAN) elements such as base stations, base station controllers (BSCs), routers, switches, and the like, arranged, connected, and programmed to provide wireless service to user equipment, report detected events, and execute actions received from the workflow server 702.

The video surveillance system 740 is configured to detect various triggers and report the detected triggers to the workflow server 702. The public-safety network 730 is also configured to receive action commands from workflow server 702 and execute the actions. For example, the video surveillance system 740 comprises a plurality of video cameras that may be configured to automatically change their field of views over time. The video cameras of the video surveillance system 740 may include image sensors described herein such as 203, 303, 403. Moreover, the video cameras can include a camera similar to the camera device 600. The video surveillance system 740 can be configured to determine/detect weapon zones for identification of unpermitted weapons or objects of interest, especially when detection is obscured by a hardware apparatus. The video surveillance system 740 is configured with a recognition engine/video analysis engine (VAE) that comprises a software engine that analyzes any video captured by the cameras. Using the VAE, the video surveillance system 740 is capable of “watching” video to detect any triggers and report the detected triggers to workflow server 702. Similarly, the video surveillance system 740 can execute action commands received from the workflow server 702.

The radio system 750 preferably comprises a private enterprise radio system that is configured to detect various triggers and report the detected triggers to the workflow server 702. The radio system 750 is also configured to receive action commands from workflow server 702 and execute the actions. For example, the radio system 750 may comprise a MOTOTRBO™ communication system having radio devices that operates in the CBRS spectrum and combines broadband data with voice communications.

The access control system 760 may comprise an IoT network. The IoT system 760 serves to connect every-day devices to the Internet. Devices such as metal detectors, object scanners (e.g., 204, 304, 402A-402B), cars, kitchen appliances, medical devices, sensors, doors, windows, HVAC systems, drones, . . . , etc. can all be connected through the IoT. Basically, anything that can be powered can be connected to the internet to control its functionality. The system 760 allows objects to be sensed or controlled remotely across existing network infrastructure. For example, the access control system 760 may be configured to provide access to an intensive care unit or other emergency area of a hospital based on entrants passing an object scan (e.g., weapon detection) checkpoint. With this in mind, the access control system 760 is configured to detect various triggers (e.g., door opened/closed) and report the detected triggers to workflow server 702. The access control system 760 is also configured to receive action commands from the workflow server 702 and execute the action received from the workflow server 702. The action commands may take the form of instructions to lock, open, and/or close a door or window.

As is evident, the above security ecosystem 700 allows an administrator using the workstation 701 to create rule-based, automated workflows between technologies to enhance efficiency, and improve response times, effectiveness, and overall safety. The above ecosystem 700 has the capability to detect triggers across a number of devices within the network and systems 730-760 quickly take actions by automatically executing the proper procedure (i.e., executing the appropriate action once a trigger is detected).

FIG. 7B illustrates a security ecosystem capable of configuring and automating workflows. In particular, FIG. 7B shows the security ecosystem 700 with an expanded view of access control system 760. As shown, the access control system 760 comprises a plurality of IoT devices 763 coupled to the gateway 762. The plurality of IoT devices 763 may include object scanners 204, 304, 402A-402B as described herein, for example. Data passed from the workflow server 702 to the IoT devices 763 passes through the network 761, gateway 762 and ultimately to the IoT device 763. Conversely, data passed from the IoT devices 763 to the workflow server 702 passes through the gateway 762, network 761, and ultimately to the workflow server 702.

As is known in the art, a particular communication protocol (IoT protocol) may be used for each IoT device. For example, various proprietary protocols such as DNP, Various IEC**** protocols (IEC 61850 etc . . . ), bacnet, EtherCat, CANOpen, Modbus/Modbus TCP, EtherNet/IP, PROFIBUS, PROFINET, DeviceNet, . . . , etc. can be used. Also a more generic protocol such as Coap, Mqtt, and RESTfull may also be used.

The gateway 762 preferably comprises an Avigilon™ Control Center running Avigilon's Access Control Management software. The gateway 762 is configured to run the necessary Application Program Interface (API) to provide communications between any IoT device 763 and the workflow server 702.

The network 761 preferably comprises one of many networks used to transmit data, such as but not limited to a network employing one of the following protocols: a Long Term Evolution (LTE) protocol, LTE-Advance protocol, or 5G protocol including multimedia broadcast multicast services (MBMS) or single site point-to-multipoint (SC-PTM) protocol over which an open mobile alliance (OMA) push to talk (PTT) over cellular protocol (OMA-PoC), a voice over IP (VoIP) protocol, an LTE Direct or LTE Device to Device protocol, or a PTT over IP (PoIP) protocol, a Wi-Fi protocol perhaps in accordance with an IEEE 802.11 standard (e.g., 802.11a, 802.11b, 802.11g) or a WiMAX protocol perhaps operating in accordance with an IEEE 802.16 standard.

As discussed herein, the security ecosystem 700 is capable of configuring and automating workflows. In particular, FIG. 7B shows the security ecosystem 700 with an expanded view of the video surveillance system 740. As shown, the video surveillance system 740 comprises a plurality of cameras 742 and gateway 741. The cameras 742 may be fixed or mobile, and may have pan/tilt/zoom (PTZ) capabilities to change their field of view. The cameras 742 may also comprise circuitry configured to serve as a video analysis engine (VAE) which comprises a software engine that analyzes analog and/or digital video. The engine is configured to “watch” video and detect pre-selected objects such as license plates, people, faces, automobiles. The software engine may also be configured to detect certain actions of individuals, such as fighting, loitering, crimes being committed, . . . , etc. The VAE may contain any of several object/action detectors.

Each object/action detector “watches” the video for a particular type of object or action. Object and action detectors can be mixed and matched depending upon what is trying to be detected. For example, a weapon object detector may be utilized to detect weapons, while a fire detector may be utilized to detect fires. The gateway 741 preferably comprises an Avigilon™ Control Center running Avigilon's Access Control Management software. The gateway 741 is configured to run the necessary Application Program Interface (API) to provide communications between any cameras 742 and the workflow server 702.

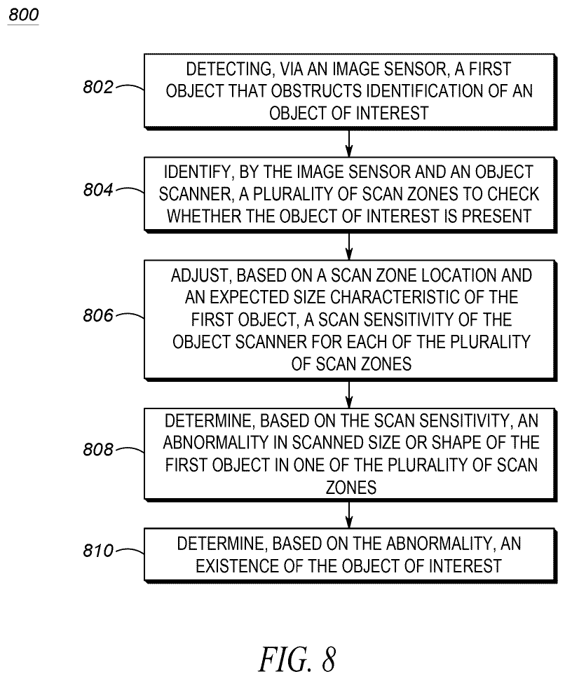

FIG. 8 illustrates an example flow diagram (e.g., process 800) to improve security of a location, according to certain aspects of the present disclosure. For explanatory purposes, the example process 800 is described herein with reference to one or more of the figures above. Further for explanatory purposes, the blocks of the example process 800 are described herein as occurring in serial, or linearly. However, multiple instances of the example process 800 may occur in parallel, overlapping in time, almost simultaneously, or in a different order from the order illustrated in the process 800. In addition, the blocks of the example process 800 need not be performed in the order shown and/or one or more of the blocks of the example process 800 need not be performed.

At step 802, a first object that potentially obstructs identification of an object of interest may be detected via an image sensor. As an example, the detection can be performed by an object detection device or a processor in communication with the image sensor (e.g., video camera) and an object scanner. For example, detecting the first object comprises performing an appearance search to correlate a hardware apparatus with an output of the image sensor. For example, detecting the first object comprises determining that the first object is the hardware apparatus that may obstruct identification of the object of interest, wherein the object of interest comprises a weapon. For example, detecting the first object comprises determining a known shape or size of the first object.

At step 804, a plurality of scan zones may be identified by the image sensor and the object scanner to check whether the object of interest is present. For example, identifying the plurality of scan zones comprises determining, by the image sensor, a plurality of voxels to label scan zone candidates in a three dimensional space. For example, identifying the plurality of scan zones comprises determining, by the object scanner, a metal zone along a two dimensional plane, wherein the object scanner comprises at least one of: a metal detector or a nanowave detector. For example, identifying the plurality of scan zones comprises identifying, based on the metal zone and the scan zone candidates, potential weapon zones as the plurality of scan zones in the three dimensional space.

At step 806, a scan sensitivity of the object scanner for each of the plurality of scan zones may be adjusted based on a scan zone location and an expected size characteristic of the first object. For example, adjusting the scan sensitivity comprises increasing the scan sensitivity based on the expected size characteristic corresponding to the scan zone location being greater than a threshold. For example, adjusting the scan sensitivity comprises decreasing the scan sensitivity based on the expected size characteristic corresponding to the scan zone location being less than the threshold. For example, adjusting the scan sensitivity comprises interoperating between the image sensor and the object scanner.

At step 808, an abnormality in scanned size or shape of the first object in one of the plurality of scan zones may be determined based on the scan sensitivity. For example, determining the abnormality in the scanned size or shape comprises determining a shape characteristic, a size characteristic and a location characteristic of the first object. According to an aspect, the status of the person may be determined based on audio or video information sensed by the camera. For example, determining the abnormality in the scanned size or shape comprises identifying a scan zone of the plurality of scan zones where the scanned size or shapes of the first object is different than what is expected based on the shape characteristic, size characteristic, and location characteristic. At step 810, an existence of the object of interest may be determined based on the abnormality. For example, determining the existence of the object of interest comprises generating, by the object scanner, an alert. For example, determining the existence of the object of interest comprises indicating, on a display, a location of the object of interest.

According to an aspect, the process 800 comprises determining, based on a machine learning model, a type of the first object. According to an aspect, the process 800 comprises adjusting, based on the type of the first object and the abnormality, a target scan area. According to an aspect, the process 800 comprises adjusting based on a scan zone location and the known shape or size of the first object, a scan sensitivity of the object scanner for each of the plurality of scan zones. According to an aspect, the process 800 comprises determining, based on the scan sensitivity, an abnormality in scanned size or shape of the first object in one of the plurality of scan zones along an axis of a three dimensional Cartesian coordinate system. According to an aspect, the process 800 comprises determining, based on the abnormality, a presence of the object of interest along the axis. As an example, determining the object of interest presence is based on the type of the first object.

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, validate digital certificates, issue tokens, and the like).

In the foregoing specification, specific examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of”, without a more limiting modifier such as “only one of”, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
detecting, via an image sensor, a first object that obstructs identification of an object of interest;
identifying, by the image sensor and an object scanner, a plurality of scan zones to check whether the object of interest is present;
adjusting, based on a scan zone location and an expected size characteristic of the first object, a scan sensitivity of the object scanner for each of the plurality of scan zones;
determining, based on the scan sensitivity, an abnormality in scanned size or shape of the first object in one of the plurality of scan zones; and
determining, based on the abnormality, an existence of the object of interest.

2. The method of claim 1, wherein detecting the first object comprises:
performing an appearance search to correlate a hardware apparatus with an output of the image sensor;
determining that the first object is the hardware apparatus that obstructs identification of the object of interest, wherein the object of interest comprises a weapon; and
determining a known shape or size of the first object.

3. The method of claim 1, wherein identifying the plurality of scan zones comprises:
determining, by the image sensor, a plurality of voxels to label scan zone candidates in a three dimensional space;
determining, by the object scanner, a metal zone along a two dimensional plane, wherein the object scanner comprises at least one of: a metal detector or a nanowave detector; and
identifying, based on the metal zone and the scan zone candidates, potential weapon zones as the plurality of scan zones in the three dimensional space.

4. The method of claim 1, wherein adjusting the scan sensitivity comprises:
increasing the scan sensitivity based on the expected size characteristic corresponding to the scan zone location being greater than a threshold; and
decreasing the scan sensitivity based on the expected size characteristic corresponding to the scan zone location less than the threshold.

5. The method of claim 1, wherein adjusting the scan sensitivity comprises interoperating between the image sensor and the object scanner.

6. The method of claim 1, wherein determining the abnormality in the scanned size or shape comprises:
determining a shape characteristic, a size characteristic and a location characteristic of the first object; and
identifying a scan zone of the plurality of scan zones where the scanned size or shapes of the first object is different than what is expected based on the shape characteristic, size characteristic, and location characteristic.

7. The method of claim 1, wherein determining the existence of the object of interest comprises:
generating, by the object scanner, an alert; and
indicating, on a display, a location of the object of interest.

8. The method of claim 1, further comprising:
determining, based on a machine learning model, a type of the first object; and
adjusting, based on the type of the first object and the abnormality, a target scan area.

9. A system comprising:
a video camera configured to visually identify a first object;
an object scanner configured to scan for a presence of an object of interest; and
a processor operatively in communication with the video camera and the object scanner that, upon executing program instructions, is configured to:
detect a first object that obstructs identification of an object of interest;
determine a known shape or size of the first object;
identify, by the image sensor and the object scanner, a plurality of scan zones to check whether the object of interest is present;
adjust, based on a scan zone location and the known shape or size of the first object, a scan sensitivity of the object scanner for each of the plurality of scan zones;
determine, based on the scan sensitivity, an abnormality in scanned size or shape of the first object in one of the plurality of scan zones along an axis of a three dimensional Cartesian coordinate system; and
determine, based on the abnormality, a presence of the object of interest along the axis.

10. The system of claim 9, wherein the processor is configured to detect the first object by being configured to:
perform an appearance search to correlate a hardware apparatus with an output of the image sensor; and
determine that the first object is the hardware apparatus that obstructs identification of the object of interest, wherein the object of interest comprises a weapon.

11. The system of claim 9, wherein the processor is configured to determine the known shape or size by determining a type of the first object based on a machine learning model.

12. The system of claim 9, wherein the processor is configured to identify the plurality of scan zones by being configured to:
determine a plurality of voxels to label scan zone candidates in the three dimensional Cartesian coordinate system;
determine a metal zone along a two dimensional plane, wherein the object scanner comprises at least one of: a metal detector or a nanowave detector; and
identify, based on the metal zone and the scan zone candidates, potential weapon zones as the plurality of scan zones in the three dimensional Cartesian coordinate system.

13. The system of claim 9, wherein the processor is configured to determine the abnormality in the scanned size or shape by being configured to:
determine a shape characteristic, a size characteristic and a location characteristic of the first object; and
identify a scan zone of the plurality of scan zones where the scanned size or shapes of the first object is different than what is expected based on the shape characteristic, size characteristic, and location characteristic.

14. The system of claim 9, wherein the processor is further configured to sensitivity by being configured to:
increase the scan sensitivity based on the expected size characteristic corresponding to the scan zone location being greater than a threshold; and
decrease the scan sensitivity based on the expected size characteristic corresponding to the scan zone location being less than the threshold.

15. An object detection device comprising:
a processor; and
a computer-readable storage medium having stored thereon program instructions that, when executed by the processor, cause the object detection device to perform a set of operations comprising:
detecting, via an image sensor component, a first object that obstructs identification of an object of interest;
identifying, by the image sensor component and an object scanner component, a plurality of scan zones to check whether the object of interest is present;
adjusting, based on a scan zone location and an expected size characteristic of the first object, a scan sensitivity of the object scanner component for each of the plurality of scan zones;
determining, based on a machine learning model, a type of the first object;
determining, based on the scan sensitivity, an abnormality in scanned size or shape of the first object in one of the plurality of scan zones; and
determining, based on the type of the first object and the abnormality, an existence of the object of interest.

16. The camera of claim 15, wherein the set of operations comprising identifying the plurality of scan zones comprise:
determining, by the image sensor, a plurality of voxels to label scan zone candidates in a three dimensional space;
determining, by the object scanner, a metal zone along a two dimensional plane; and
identifying, based on the metal zone and the scan zone candidates, potential weapon zones as the plurality of scan zones in the three dimensional space.

17. The camera of claim 15, wherein the set of operations comprising adjusting the scan sensitivity comprise:
increasing the scan sensitivity based on the expected size characteristic corresponding to the scan zone location being greater than a threshold; and
decreasing the scan sensitivity based on the expected size characteristic corresponding to the scan zone location being less than the threshold.

18. The camera of claim 15, wherein the set of operations comprising determining the abnormality in the scanned size or shape comprise:
determining a shape characteristic, a size characteristic and a location characteristic of the first object; and
identifying a scan zone of the plurality of scan zones where the scanned size or shapes of the first object is different than what is expected based on the shape characteristic, size characteristic, and location characteristic.

19. The camera of claim 15, wherein the set of operations further comprise adjusting, based on the type of the first object and the abnormality, a target scan area.

20. The camera of claim 15, wherein the set of operations comprising determining the existence of the object of interest comprises:
generating, by the object scanner component, an alert; and
indicating, on a display component, a location of the object of interest.
